(19) United States
(12) Patent Application Publication
(10) Pub. No.: US 2025/0067325 A1
(43) Pub. Date: Feb. 27, 2025

(54) PARALLEL LINK MECHANISM, TRANSFER DEVICE, AND WORK ROBOT

(71) Applicants: SINTOKOGIO, LTD., Nagoya-shi (JP); UNIVERSITY OF YAMANASHI, Kofu-shi (JP)

(72) Inventors: Yoshikane TANAAMI, Nagoya-shi (JP); Miyuki HAYASHI, Nagoya-shi (JP); Yoshiyuki NODA, Kofu-shi (JP); Yoshitaka AOKI, Kofu-shi (JP)

(73) Assignees: SINTOKOGIO, LTD., Nagoya-shi (JP); UNIVERSITY OF YAMANASHI, Kofu-shi (JP)

(21) Appl. No.: 18/808,567

(22) Filed: Aug. 19, 2024

(30) Foreign Application Priority Data
Aug. 22, 2023 (JP) 2023-134822

(51) Int. Cl. F16H 21/52; B25J 9/10; B62D 55/06

(52) U.S. Cl. CPC F16H 21/52; B25J 9/1065; B62D 55/06

(57) ABSTRACT

A parallel link mechanism includes: a base including guide members; moving bodies capable of moving along the guide members; a fixed link having a base end portion fixed to the base and extending in a direction away from the base; a turning body being connected to a distal end portion of the fixed link and being turnable around the distal end portion; and movable links having base end portions connected to the moving bodies and distal end portions connected to the turning body and causing the turning body to turn along with movement of the moving bodies, the guide members being inclined so as to get closer to the turning body as the guide members get farther away from the center portion of the base main body.

This Nonprovisional application claims priority under 35 U.S.C. § 119 on Patent Application No. 2023-134822 filed in Japan on Aug. 22, 2023, the entire contents of which are hereby incorporated by reference.

### TECHNICAL FIELD

The present invention relates to a parallel link mechanism, a transfer device, and a robot for work (work robot).

### BACKGROUND ART

Conventionally, there has been known a carrier part stabilizing device such as the one disclosed in Patent Literature 1. The carrier part stabilizing device includes a base part, a carrier part, a center support part, a first lifting support part, and a second lifting support part. The center support part keeps a distance between the base part and a center portion of a lower surface of the carrier part constant, and supports the carrier part so that an angle of the carrier part with respect to the base part is freely changeable. The first lifting support part is disposed in front of or in the rear of the center support part so as to be appropriately spaced from the center support part as viewed in a traveling direction. The second lifting support part is disposed orthogonally to the traveling direction so as to be appropriately spaced from the center support part. Each of the lifting support parts is subjected to lifting control carried out via a link mechanism. The link mechanism includes: a driving arm configured to be rotated by rotational driving force of a servomotor; and a lifting shaft connected to a distal end of the driving arm via a spherical bearing, a distal end of the lifting shaft being connected to a back side of the carrier part via a spherical bearing.

### CITATION LIST

### Patent Literature

### [Patent Literature 1]

Japanese Patent Application Publication, Tokukai, No. 2019-93981

### SUMMARY OF INVENTION

### Technical Problem

A transfer device that keeps the carrier part horizontal with use of such a parallel link mechanism is expected to be used in various places. According to the above-described conventional technique, however, a turning width of the carrier part with respect to the base part is small, and thus it is sometimes impossible to keep the carrier part horizontal on a largely inclined slope. Therefore, it is difficult to use the conventional technique in industries involving work carried out on a steep slope, such as forestry. Here, the turning width of the carrier part with respect to the base part can be increased to some degrees by increasing a size of a mechanism for causing the carrier part to be inclined. However, increasing the size of the mechanism increases a size of the entire transfer device, thereby causing a new problem. The new problem may be, for example, difficulty in loading and unloading of an object to be loaded (i.e., a load object) due to a too high height of the carrier part, difficulty in passing through a road due to its too large width, or the like. Further, such a tradeoff relation between the turning width and the size of the mechanism had been a problem also in the field of work robots.

An aspect of the present invention was made in consideration of the above problem, and has an object to increase, in a parallel link mechanism configured to turn a turning body by operation of a movable link, a turning width of the turning body without increasing a size of the mechanism.

### Solution to Problem

In order to attain the above object, a parallel link mechanism in accordance with an aspect of the present invention includes: a base including a base main body and a plurality of guide members extending from a center portion of the base main body in directions away from the center portion of the base main body toward a periphery of the base main body, the directions being different from each other; a plurality of moving bodies which are movable along the plurality of guide members, respectively; a fixed link having a base end portion fixed to the center portion of the base main body, the fixed link extending in a direction away from the base;

a turning body having a center portion connected to a distal end portion of the fixed link, the turning body being turnable around the distal end portion; a plurality of movable links having (i) base end portions respectively connected to the plurality of moving bodies and (ii) distal end portions connected to a periphery of the turning body, the plurality of movable links causing the turning body to turn along with movement of the moving bodies; a sensor configured to detect inclination of the turning body with respect to a horizontal plane; and a processor configured to control, on a basis of a result of detection carried out by the sensor, movement of the plurality of moving bodies so that the turning body is inclined with respect to the horizontal plane to a desired degree, at least any one of the plurality of guide members being inclined so as to get closer to the turning body as the at least any one of the plurality of guide members gets farther away from the center portion of the base main body.

In order to attain the above object, a transfer device in accordance with another aspect of the present invention includes: a traveling mechanism capable of traveling on a ground; and the above-described parallel link mechanism, the parallel link mechanism being mounted above the traveling mechanism.

In order to attain the above object, a work robot in accordance with another aspect of the present invention includes: the above-described parallel link mechanism; and a tool attached to the lower surface of the turning body of the parallel link mechanism.

### Advantageous Effects of Invention

According to each aspect of the present invention, it is possible to increase, in a parallel link mechanism configured to turn a turning body by operation of a movable link, a turning width of the turning body without increasing a size of the mechanism.

### BRIEF DESCRIPTION OF DRAWINGS

FIG. 1 is a perspective view illustrating an example of a transfer device in accordance with a first embodiment of the present invention.

FIG. 2 is a block diagram illustrating an electrical configuration of a parallel link mechanism included in the device (a work robot in accordance with a second embodiment of the present invention).

FIG. 3 is a perspective view illustrating a base, moving bodies, and a fixed link included in the mechanism.

FIG. 4 is an enlarged perspective view of a part of FIG. 3.

FIG. 5 is a perspective view illustrating a distal end portion of the fixed link included in the mechanism.

FIG. 6 is a flowchart illustrating a flow of a process executed by a processor of the mechanism.

FIG. 7 is a side view illustrating a transfer device traveling on a slope.

FIG. 8 is a perspective view illustrating an example of a work robot in accordance with a second embodiment of the present invention.

FIG. 9 is a flowchart illustrating a flow of a process executed by a processor of a parallel link mechanism included in the robot.

### DESCRIPTION OF EMBODIMENTS

### First Embodiment

The following description will discuss a first embodiment of the present invention with reference to the drawings.

### <Configuration of Transfer Device>

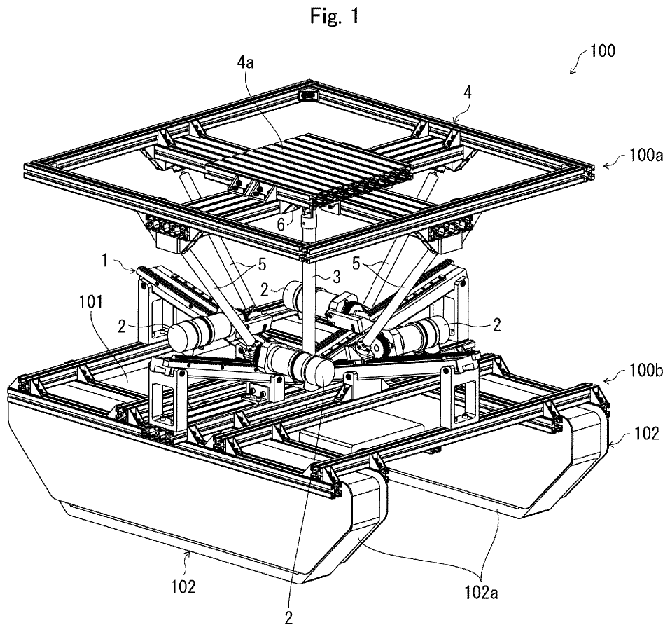

The first embodiment of the present invention is a transfer device 100. The transfer device 100 transfers a load object. There is no particular limitation on the load object. The transfer device 100 is suitably used to transfer, e.g., a working tool for people engaged in forestry, lumber having been cut down, and/or the like. As shown in FIG. 1, the transfer device 100 includes a parallel link mechanism 100a and a traveling mechanism 100b.

### [Traveling Mechanism]

The traveling mechanism 100b is configured to be capable of traveling on a ground. The traveling mechanism 100b in accordance with the present embodiment includes a motive power source 101 and a pair of left and right continuous tracks 102. The motive power source 101 is an engine or a motor. Each of the continuous tracks 102 includes: a drive wheel (not illustrated) rotated by motive power from the motive power source 101; a guide wheel and a rolling wheel (each not illustrated); and a covering plate 102a which surrounds these elements and which moves along with rotation of the drive wheel. With this, the traveling mechanism 100b can move even on a bad road (a road having an obstacle such as a stone and/or the like, a largely inclined slope) such as a mountain path. Further, the traveling mechanism 100b includes a manipulation part (not illustrated) for controlling the motive power source 101. Note that the traveling mechanism 100b may not include the covering plate 102a, and may be constituted by the motive power source 101 and the driving wheels. The traveling mechanisms 100b may not be a dedicated device, but may be a commercially-available vehicle.

### [Configuration of Parallel Link Mechanism]

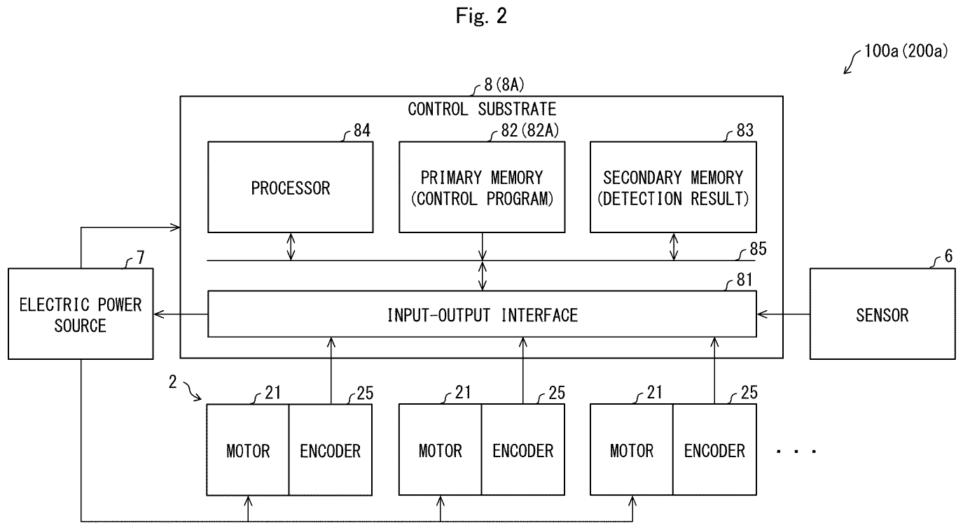

The parallel link mechanism 100a is mounted above the traveling mechanism 100b. The parallel link mechanism 100a includes a base 1, a plurality of moving bodies 2, a fixed link 3, a turning body 4, and a plurality of movable links 5. As shown in FIG. 2, the parallel link mechanism 100a further includes a sensor 6, an electric power source 7, and a control substrate 8. The electric power source 7 and the control substrate 8 may be dedicated for the parallel link mechanism 100a or may be shared by the parallel link mechanism 100a and the traveling mechanism 100b.

### [Base]

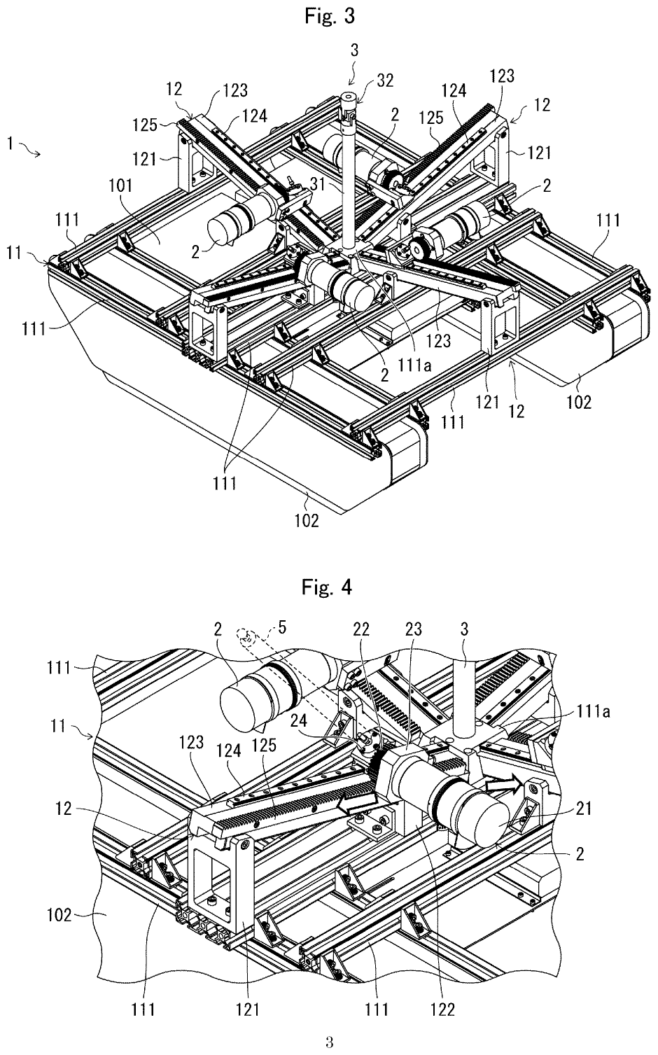

As shown in FIG. 3, the base 1 includes a base main body 11 and a plurality of support members 12. The base 1 in accordance with the present embodiment includes four support members 12. Note that the number of the support members 12 included in the base 1 may be not more than three or not less than five.

### (Base Main Body)

The base main body 11 fixes the parallel link mechanism 100a to the traveling mechanism 100b. The base main body 11 in accordance with the present embodiment is constituted by a plurality of bar-shaped fixed members 111. The plurality of fixed members 111 are arranged in a front-rear direction (a direction connecting an upper left side and a lower right side in FIG. 3). The fixed members 111 are arranged so as to extend in a left-right direction (a direction connecting an upper right side and a lower left side in FIG. 3), and are hung over between the pair of continuous tracks 102. Further, left and right end portions of each of the fixed members 111 are fixed to the pair of continuous tracks 102. A fixed member 111 disposed so as to pass through a center portion of the traveling mechanism 100b when viewed in a plan view has a center portion provided with a support part 111a that supports a base end portion of the fixed link 3. Note that the base main body 11 may be constituted by a single member. The support part 111a may be provided to the traveling mechanism 100b (e.g., a location above the motive power source 101), rather than to the fixed member 111.

### (Support Member)

As shown in FIG. 4, each of the support members 12 in accordance with the present embodiment includes a first support pillar 121, a second support pillar 122, a girder part 123, a guide member 124, and a rack 125.
Pillar

The first support pillars 121 and the second support pillars 122 support their corresponding girder parts 123. As shown in FIG. 3, one of the first support pillars 121 is attached to a left end portion of the fixed member 111 extending through the center portion of the traveling mechanism 100b, another one of the first support pillars 121 is attached to a right end portion of the fixed member 111 extending through the center portion of the traveling mechanism 100b, another one of the first support pillars 121 is attached to a center portion of a fixed member 111 extending through a front end portion of the traveling mechanism 100b, and the other one of the first support pillars 121 is attached to a center portion of a fixed member 111 extending through a rear end portion of the traveling mechanism 100b, in such a manner that the first support pillars 121 extend upward. As shown in FIG. 4, the first support pillars 121 are higher in height than the second support pillars 122. Each of the second support pillars 122 is attached to a portion of a corresponding one of the fixed members 111 which portion exists between the support part 111a of the fixed members 111 and a corresponding one of the first support pillars 121, in such a manner that the second support pillar 122 extends upward. The second support pillars 122 are lower in height than the first support pillars 121. Note that at least either of the first support pillars 121 and the second support pillars 122 may be attached to the traveling mechanism 100b. In this case, the base 1 may not include the fixed members 111.

### Girder Part

The girder parts 123 are disposed so as to extend from the support part 111a of the fixed members 111 to the respective first support pillars 121 (front, rear, left, and right). Each of the girder parts 123 has two opposite end portions respectively fixed to an upper end portion of a corresponding one of the first support pillars 121 and an upper end portion of a corresponding one of the second support pillars 122. Thus, the girder parts 123 extend from a center portion of the base main body 11 to a front side, a rear side, a left side, and a right side, respectively. As discussed above, the first support pillars 121, which support the girder parts 123 at locations farther from the support part 111a, are higher in height than the second support pillars 122. Thus, the girder parts 123 are inclined so as to be raised as the girder parts 123 get farther away from the center portion of the base main body 11. It is preferable that an inclined angle of each of the girder parts 123 (i.e., an angle made by an upper surface of the girder part 123 and a horizontal plane) be within a range of 10° to 20°. The inclined angle in the present embodiment is 15°. Note that the girder parts 123 may be supported by the first support pillars 121 and the support part 111a of the fixed member 111. In this case, the base 1 may not include the second support pillars 122.

### Guide Member

The guide members 124 guide the respective moving bodies 2. Each of the guide members 124, provided on the upper surface of a corresponding one of the girder parts 123, extends along a direction in which the corresponding one of the girder parts 123 extends. As discussed above, the girder parts 123 extend to the front side, the rear side, the left side, and the right side, respectively. Thus, the plurality of guide members 124 in accordance with the present embodiment also extend from the center portion (support part 111a) of the base main body 11 to the front side, the rear side, the left side, and the right side, respectively. Further, as discussed above, the girder parts 123 are inclined. Thus, all the plurality of guide members 124 are inclined so as to be raised as the plurality of guide members 124 get farther away from the center portion of the base main body 11. Note that each of the guide members 124 may be provided on a side surface or a lower surface of a corresponding one of the girder parts 123.

### Rack

The racks 125 are provided on upper surfaces of the respective girder parts 123 so as to extend in parallel with the respective guide members 124. Note that each of the racks 125 may be provided on a side surface or a lower surface of a corresponding one of the girder parts 123. Further, each of the racks 125 may be provided to a surface of a corresponding one of the girder parts 123, the surface being different from the surface on which the guide member 124 is provided.

### (Base and the Others)

Note that the plurality of girder parts 123 (the plurality of guide members 124, the plurality of racks 125) may extend in directions away from the center portion of the base main body 11 toward a periphery of the base 1, the directions being different from each other. Thus, at least part of the plurality of girder parts 123 may be disposed so as to extend from the center portion of the base main body 11 in an (obliquely) lateral direction which is not a direction toward the front side, the rear side, the left side, or the right side. Further, at least part of the plurality of girder parts 123 (the plurality of racks 125, the plurality of guide members 124) may be inclined so as to be raised as the at least part of these parts get(s) farther away from the center portion of the base main body 11. That is, part of the plurality of girder parts 123 may not be inclined.

### [Moving Body]

The plurality of moving bodies 2 are movable along the respective guide members 124. As shown in FIG. 4, each of the moving bodies 2 includes a motor 21, a pinion 22, a decelerator 23, and a connecting part 24. Further, as shown in FIG. 2, each of the moving bodies 2 further includes an encoder 25.

### (Motor)

The motors 21 are rotated according to control of a processor 84 of the later-described control substrate 8. Each of the motors 21 in accordance with the present embodiment is a direct drive motor. Thus, the motors 21 can cause the moving bodies 2 (base end portions of the movable links 5) to move at high speed with high precision. Further, with the motors 21, it is possible to fix positions of the moving bodies 2 merely by stopping electric power supply. Note that each of the motors 21 may be a motor which is not a direct drive motor.

### (Pinion)

As shown in FIG. 4, each of the pinions 22 engages with a corresponding one of the racks 125, and is rotated according to rotation of a corresponding one of the motors 21. As a result of rotation of the pinion 22, a corresponding one of the moving bodies 2 moves along the corresponding one of the racks 125.

### (Decelerator)

The decelerators 23 are provided between the motors 21 and the pinions 22, respectively. Each of the decelerators 23 includes another gear interposed between a gear directly attached to a rotational shaft of a corresponding one of the motors 21 and a corresponding one of the pinions 22. By the another gear, the decelerator 23 improves torque of the pinion 22.

### (Connecting Part)

The connecting parts 24 are connected to the base end portion of the movable links 5, respectively. Each of the connecting parts 24 in accordance with the present embodiment is constituted by a ball joint. Each of the connecting parts 24 in accordance with the present embodiment engages with the guide member 124 of a corresponding one of the support members 12, and is slidable with respect to the guide member 124. Note that a member engaging with the guide member 124 may be a member which is in the moving body 2 and which is not the connecting part 24.

### (Encoder)

Each of the encoders 25 detects a rotation direction and a rotation angle of a corresponding one of the motors 21. Then, the encoder 25 outputs a detection result to the processor 84 of the control substrate 8.

### [Fixed Link]

As shown in FIG. 3, the fixed link 3 has the base end portion fixed to the center portion of the base main body 11, and extends in a direction away from the base 1. The fixed link 3 in accordance with the present embodiment extends upward from the center portion of the base main body 11. The fixed link 3 in accordance with the present embodiment includes a link main body 31 and a movable joint 32. The movable joint 32 is attached above the link main body 31. That is, a distal end portion of the fixed link 3 is the movable joint 32.

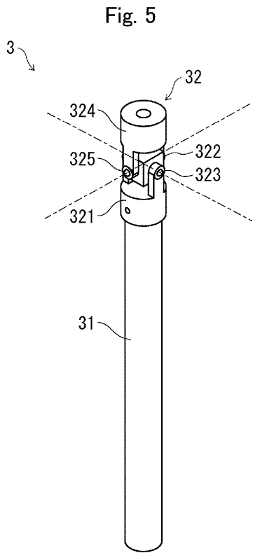

As shown in FIG. 5, the movable joint 32 in accordance with the present embodiment includes a first member 321, a second member 322, a first shaft part 323, a third member 324, and a second shaft part 325. The first member 321 is fixed to the distal end portion of the link main body 31. The second member 322 is pivotally supported by the first member 321 via the first shaft part 323 extending in the front-rear direction. Consequently, the second member 322 is rotatable around the first shaft part 323 with respect to the first member 321. The third member 324 is pivotally supported by the second member 322 via the second shaft part 325 extending in a direction orthogonal to a direction along which the first shaft part 323 extends (when the second member 322 is not rotating, the second shaft part 325 extends in the left-right direction). Consequently, the third member 324 is rotatable around the second shaft part 325 with respect to the second member 322. Note that the movable joint 32 may include either one of the first shaft part 323 and the second shaft part 325 (i.e., may not include the other). Further, in the movable joint 32, the first shaft part 323 may extend in the left-right direction. Further, the movable joint 32 may include a shaft part extending in a direction different from the direction in which the first shaft part 323 extends or a direction in which the second shaft part 325 extends.

### [Turning Body]

As shown in FIG. 1, a center portion of the turning body 4 is connected to the distal end portion (movable joint 32) of the fixed link 3. The turning body 4 in accordance with the present embodiment is disposed above the base 1. Further, a center portion of a lower surface of the turning body 4 is connected to the distal end portion of the fixed link 3. As discussed above, the distal end portion of the fixed link 3 is the movable joint 32. Consequently, the turning body 4 is turnable about the distal end portion of the fixed link 3. To be more specific, the turning body 4 is connected to the fixed link 3 such that (i) the turning body 4 is turnable around the first shaft part 323 of the movable joint 32 and (ii) the turning body 4 is turnable around the second shaft part 325 of the movable joint 32. This enables the turning body 4 to be inclined in all directions with respect to the base 1, similarly to a case where a ball joint is used. Meanwhile, the movable joint 32 does not include a shaft part extending in a direction in which the fixed link 3 extends. Thus, the turning body 4 is restricted from turning around a shaft part extending in the direction in which the fixed link 3 extends. That is, the “turning” operation of the turning body 4 does not include turning around a straight line extending in the direction in which the fixed link 3 extends. Further, the turning body 4 in accordance with the present embodiment is a load-carrying tray having an upper surface on which a load object can be placed. Hereinafter, the turning body 4 in accordance with the present embodiment will be expressed as a “load-carrying tray 4”. The load-carrying tray 4 in accordance with the present embodiment is in the shape of a quadrangular plate in a plan view. The upper surface of the load-carrying tray 4 is a placement surface 4a on which a load object is to be placed.

### [Movable Link]

As shown in FIG. 4, the plurality of movable links 5 have base end portions connected to the moving bodies 2 (connecting parts 24), respectively. As discussed above, the moving bodies 2 are provided to the guide members 124 extending from the center portion of the base main body 11 to the front side, the rear side, the left side, and the right side, respectively. Thus, as shown in FIG. 1, the plurality of movable links 5 are arranged so as to surround the fixed link 3. The base end portions of the movable links 5 in accordance with the present embodiment are connected to the moving bodies 2 via ball joints. Further, distal end portions of the plurality of movable links 5 are connected to a periphery of the load-carrying tray 4. As shown in FIG. 1, the distal end portions of the movable links 5 in accordance with the present embodiment are connected to front, rear, left, and right end portions of the load-carrying tray 4, respectively. To be more specific, a distal end portion of a movable link 5 whose base end portion is connected to a moving body 2 disposed on the front side (rear side) is connected to the front end portion (rear end portion) of the load-carrying tray 4. Further, a distal end portion of a movable link 5 whose base end portion is connected to a moving body 2 disposed on the right side (left side) is connected to the right end portion (left end portion) of the load-carrying tray 4. The distal end portions of the movable links 5 in accordance with the present embodiment are connected to the load-carrying tray 4 via ball joints. Note that the distal end portions of the movable links 5 may be connected to portions (e.g., portions closer to the center portion than the end portions are, four corners of the load-carrying tray 4, etc.) of the load-carrying tray 4, each of the portions being not the front, rear, left, or right end portion.

With this, the left, right, front, and rear end portions of the load-carrying tray 4 are supported by the movable links 5 located below the respective end portions. Thus, even in a state where a load object is placed on an end portion of the placement surface 4a, the load-carrying tray 4 can keep the load object placed thereon continuously in a stable manner. Therefore, a person can place a load object on the load-carrying tray 4 even without considering where in the placement surface 4a the load object is to be placed. That is, according to the transfer device 100 including the above-described load-carrying tray 4, it is possible to enhance efficiency of a work of placing a load object. Further, the periphery of the load-carrying tray 4 is entirely supported by the plurality of movable links 5. Further, the plurality of movable links 5 which are connected to the moving bodies 2 and to the load-carrying tray 4 causes the load-carrying tray 4 to turn along with movement of the moving bodies 2. Thus, the load-carrying tray 4 can keep the placement surface 4a horizontal more reliably.

### [Sensor]

The sensor 6 detects inclination of the placement surface 4a of the load-carrying tray 4 with respect to the horizontal plane. The sensor 6 in accordance with the present embodiment is constituted by a first angle sensor and a second angle sensor. The first angle sensor detects inclination of the placement surface 4a in the front-rear direction (i.e., an angle α made by (i) a line of intersection of a plane extending in the front-rear direction and in a vertical direction and the placement surface 4a and (ii) a line of intersection of the plane and the horizontal plane). The second angle sensor detects inclination of the placement surface 4a in the left-right direction (i.e., an angle β made by (i) a line of intersection of a plane extending in the left-right direction and in the vertical direction and the placement surface 4a and (ii) a line of intersection of the plane and the horizontal plane). Each of the angle sensors detects a rotation angle repeatedly at a given cycle, and outputs a detection result to the processor 84 repeatedly. Note that the sensor 6 may be constituted by: a gyro sensor which detects an angular velocity and an angular acceleration; and a processor which calculates, on the basis of a result of the detection, an angle made by the horizontal plane and the placement surface 4a. Further, the sensor 6 may be constituted by: a plurality of position sensors each of which detects a height of each part of the load-carrying tray 4; and a processor which calculates, on the basis of a result of the detection, an angle made by the horizontal plane and the load-carrying tray 4a.

### [Electric Power Source]

The electric power source 7 is constituted by a battery (not illustrated) and an electric power source circuit (not illustrated). The electric power source circuit constantly supplies, to the sensor 6 and the control substrate 8, electric power from the battery. Further, in accordance with an instruction from the processor 84, the electric power source circuit supplies, to the motor 21, electric power from the battery.

### [Control Substrate]

As shown in FIG. 2, the control substrate 8 includes an input-output interface 81, a primary memory 82, a secondary memory 83, and the processor 84. These elements are electrically connected with each other via a bus 85.

### (Input-Output Interface)

The input-output interface 81 connects (i) the encoders 25, the sensor 6, and the electric power source circuit of the electric power source 7 with (ii) the processor 84. Further, the input-output interface 81 connects (i) the encoders 25 and the sensor 6 with (ii) the secondary memory 83.

### (Memory)

The primary memory 82 has a control program stored therein, the control program causing at least the parallel link mechanism 100a to operate. The secondary memory 83 is configured to allow a detections result(s) from the encoder(s) 25 and the sensor 6 to be stored therein.

### (Processor)

The processor 84 controls, on the basis of the detection result from the sensor 6, movement of the plurality of moving bodies 2 so that the load-carrying tray 4 is inclined with respect to the horizontal plane to a desired degree. Upon detection of the placement surface 4a of the load-carrying tray 4, the processor 84 in accordance with the present embodiment controls movement of the plurality of moving bodies 2 so that the inclination of the placement surface 4a is eliminated. To be more specific, when a given start condition is established, the processor 84 executes a front-rear direction process and a left-right direction process in parallel. The start condition may be, for example, that the electric power source 7 of the transfer device 100 (parallel link mechanism 100a) is turned on, that a load object is placed on the load-carrying tray 4, that the manipulation part is manipulated, that the transfer device 100 starts moving, and/or the like.

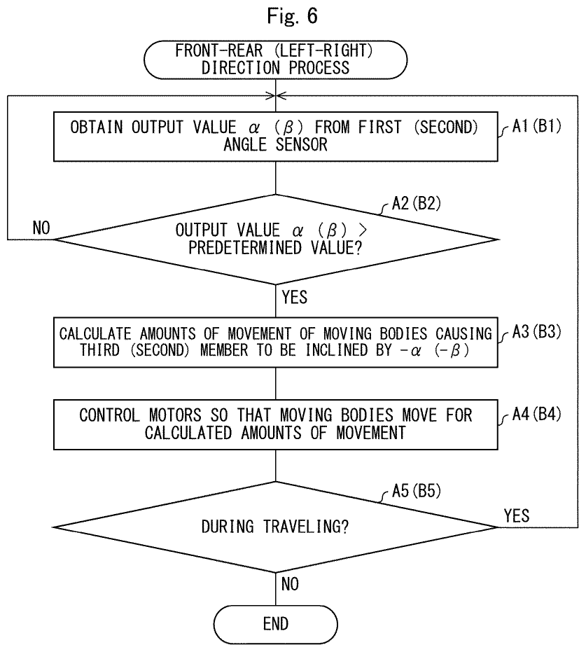

As shown in FIG. 6, in the front-rear direction process, the processor 84 repeatedly executes an obtaining step A1, a first determination step A2, a calculation step A3, a control step A4, and a second determination step A5. First, in the obtaining step A1, the processor 84 obtains an output value a (detected inclination in the front-rear direction) from the first angle sensor. Subsequently, in the first determination step A2, the processor 84 determines whether or not the output value a is more than a given value (e.g.,) 0°. If the processor 84 determines that the output value α is not more than the given value (A2: NO), the process returns to the obtaining step A1. Meanwhile, if the processor 84 determines that the output value α is more than the given value (A2: YES), the process advances to the calculation step A3. In the calculation step A3, the processor 84 calculates (i) an amount of movement of a moving body 2 located in front of the fixed link 3 and (ii) an amount of movement of a moving body 2 located in the rear of the fixed link 3, the amounts of movement of the moving bodies 2 causing the third member 324 of the movable joint 32 to be inclined with respect to the second member 322 by-a. Subsequently, in the control step A4, the processor 84 controls the motor 21 of the moving body 2 located in front of the fixed link 3 so that the moving body 2 moves closer to or away from the center portion of the base main body 11 for the amount of movement calculated in the calculation step A3. Further, in the control step A4, the processor 84 controls the motor 21 of the moving body 2 located in the rear of the fixed link 3 so that the moving body 2 moves away from or closer to the center portion of the base main body 11 until the placement surface 4a of the load-carrying tray 4 becomes horizontal. Subsequently, in the second determination step A5, the processor 84 determines whether or not the transfer device 100 (traveling mechanism 100b) is traveling. If the processor 84 determines that the transfer device 100 is traveling (A5: YES), the process returns to the obtaining step A1. Meanwhile, if the processor 84 determines that the transfer device 100 is not traveling (A5: NO), the processor 84 ends the front-rear direction process.

In the left-right direction process, the processor 84 repeatedly executes an obtaining step B1, a first determination step B2, a calculation step B3, a control step B4, and a second determination step B5. First, in the obtaining step B1, the processor 84 obtains an output value β (detected inclination in the left-right direction) from the second angle sensor. Subsequently, in the first determination step B2, the processor 84 determines whether or not the output value β is more than a given value (e.g.,) 0°. If the processor 84 determines that the output value β is not more than the given value (B2: NO), the process returns to the obtaining step B1. Meanwhile, if the processor 84 determines that the output value β is more than the given value (B2: YES), the process advances to the calculation step B3. In the calculation step B3, the processor 84 calculates (i) an amount of movement of a moving body 2 located rightward of the fixed link 3 and (ii) an amount of movement of a moving body 2 located leftward of the fixed link 3, the amounts of movement of the moving bodies 2 causing the second member 322 of the movable joint 32 to be inclined with respect to the first member 321 by-B. Subsequently, in the control step B4, the processor 84 controls the motor 21 of the moving body 2 located rightward of the fixed link 3 so that the moving body 2 moves closer to or away from the center portion of the base main body 11 for the amount of movement calculated in the calculation step B3. Further, in the control step B4, the processor 84 controls the motor 21 of the moving body 2 located leftward of the fixed link 3 so that the moving body 2 moves away from or closer to the center portion of the base main body 11 until the placement surface 4a of the load-carrying tray 4 becomes horizontal. Subsequently, in the second determination step B5, the processor 84 determines whether or not the transfer device 100 is traveling. If the processor 84 determines that the transfer device 100 is traveling (B5: YES), the process returns to the obtaining step B1. Meanwhile, if the processor 84 determines that the transfer device 100 is not traveling (B5: NO), the processor 84 ends the left-right direction process.

The processor 84 in accordance with the present embodiment causes the motors 21 to rotate on the basis of detection results from the encoders 25. This eliminates the need for the processor 84 itself to acknowledge rotation directions and rotation angles of the motors 21 (e.g., to measure periods of time of electric power supply to the motors 21). This makes it possible to simplify the control to be carried out by the processor 84.

### <Operation of Transfer Device (Parallel Link Mechanism)>

The transfer device 100 configured as above is configured to allow a load object to be placed on the placement surface 4a of the load-carrying tray 4. As discussed above, the transfer device 100 (parallel link mechanism 100a) is configured such that the center portion of the load-carrying tray 4 is supported by the fixed link 3. That is, the transfer device 100 (parallel link mechanism 100a) has high rigidity as a whole. Further, the transfer device 100 (parallel link mechanism 100a) is configured such that, instead of the movable links 5, the fixed link 3 takes a load of the load object applied to the center portion of the load-carrying tray 4. Further, as discussed above, the decelerators 23 are provided between the motors 21 and the pinions 22, respectively. Thus, the moving bodies 2 would not be moved by a load from the load-carrying tray 4. Thus, the transfer device 100 can take a heavy load object loaded thereon in a stable manner.

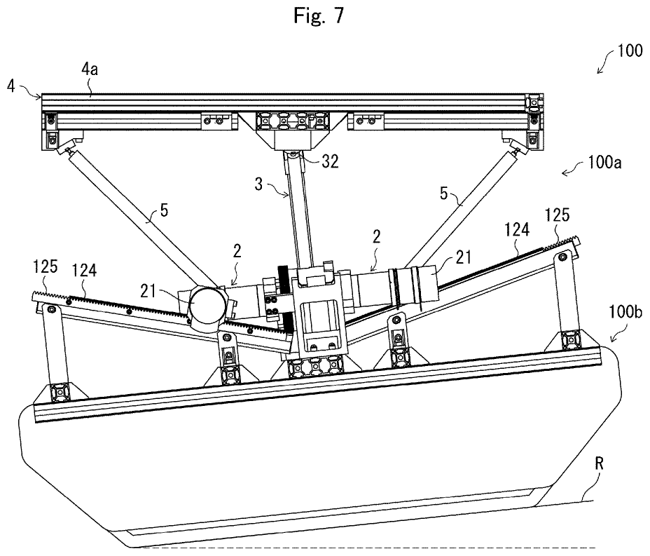

When the manipulation part (not illustrated) is manipulated by a user, the motive power source 101 supplies motive power to the pair of continuous tracks 102 so that the transfer device 100 starts traveling in a direction and at a speed according to the manipulation carried out for the manipulation part. When the transfer device 100 starts traveling, the sensor 6 repeatedly detects inclination of the placement surface 4a of the load-carrying tray 4 with respect to the horizontal plane. If the transfer device 100 climbs up an obstacle or enters a slope, etc., the transfer device 100 is entirely inclined. At this time, the load-carrying tray 4 is also inclined, and the sensor 6 detects tilting of the placement surface 4a. Then, the processor 84 controls the motors 21 of the moving bodies 2 to cause the moving bodies 2 to move. Movement of the moving bodies 2 causes the movable links 5 to move, so that the load-carrying tray 4 turns around the first shaft part 323 and/or the second shaft part 325 of the movable joint 32 of the fixed link 3. Thus, as shown in FIG. 7, the parallel link mechanism 100a can keep the placement surface 4a horizontal even when the traveling mechanism 100b is inclined according to the state of a road surface R. As discussed above, the four guide members 124 used to move the moving bodies 2 extend from the center portion of the base main body 11 to the front side, the rear side, the left side, and the right side, respectively. Thus, the transfer device 100 can keep the placement surface 4a horizontal regardless of the direction in which the base 1 is inclined.

Particularly, in mountains, forests, and/or the like, inclination of a slope may suddenly or frequently change during traveling. However, as discussed above, each of the motors 21 is a direct drive motor. Thus, even if the base 1 is suddenly inclined or inclination of the base 1 frequently changes, the transfer device 100 (parallel link mechanism 100a) can cause the movable links 5 to move at high speed with high precision to keep the placement surface 4a of the load-carrying tray 4 horizontal. Further, as discussed above, the decelerators 23 are provided between the motors 21 and the pinions 22, respectively. Thus, even when a large load is instantly applied to the moving bodies 2 from the load-carrying tray 4 due to a change in inclination, the moving bodies 2 would not be moved.

If no changes occurs in inclination while the transfer device 100 (parallel link mechanism 100a) is traveling, the processor 84 stops electric power supply to the motors 21. As discussed above, each of the motors 21 is a direct drive motor. Therefore, merely by stopping electric power supply to the motors 21, the transfer device 100 (parallel link mechanism 100a) can cause the moving bodies 2 (the base end portions of the links) to be fixed at the places.

### <Effects of Parallel Link Mechanism and Transfer Device>

As discussed above, the parallel link mechanism 100a explained above is configured such that the guide members 124 are inclined so as to be raised (i.e., so as to get closer to the load-carrying tray 4) as the guide members 124 get farther away from the center portion of the base main body 11. Thus, the parallel link mechanism 100a has a smaller horizontal width, as compared to conventional parallel link mechanisms in which equal-length guide members are horizontally arranged. That is, the parallel link mechanism 100a is made compact. In other words, by increasing a horizontal width within a range the horizontal width does not exceed those of the conventional parallel link mechanisms, the parallel link mechanism 100a can increase lengths of the guide members 124 (i.e., movable ranges of the moving bodies 2) as compared to the conventional parallel link mechanisms. Further, due to the configuration in which the girder parts 123, the guide members 124, and the racks 125 are inclined, when the moving bodies 2 move, the moving bodies 2 and the movable links 5 are displaced also in the direction in which the fixed link 3 extends. The displacement of the moving bodies 2 and the movable links 5 in the direction in which the fixed link 3 extends is added to operation of the movable links 5 for turning the load-carrying tray 4. Thus, the parallel link mechanism 100a can increase the turning width of the load-carrying tray 4 obtained by causing the moving bodies 2 to move for a given distance, as compared to that obtained when the conventional parallel link mechanism, the guide members are arranged horizontally, causes the moving bodies to move for the same distance. Thus, the parallel link mechanism 100a can achieve an increased turning width of the load-carrying tray 4 even without increasing the size of the mechanism.

Further, even without increasing the size of the device, the transfer device 100, which includes the above-described parallel link mechanism 100a, can keep the placement surface 4a horizontal (i.e., can transfer a load object in a stable manner) on a slope which is inclined to a degree (e.g., at approximately) 20° to which it is difficult for the conventional transfer devices to keep the load-carrying tray horizontal. Thus, the transfer device 100 can be used even in industries involving a work difficult to be carried out on a steep slope, such as forestry. Further, even with the turning body 4 having an increased turning width, the transfer device 100 has a size (width, height) equal to or smaller than those of the conventional transfer devices, and thus can allow loading and unloading of a load object and can pass through a road in the same manner as conventional.

### Second Embodiment

Next, the following will describe details of a embodiment of the present invention. For second convenience of explanation, members having the same functions as those described in the first embodiment are given the same reference numerals, and explanations thereof are omitted here.

### <Configuration of Work Robot>

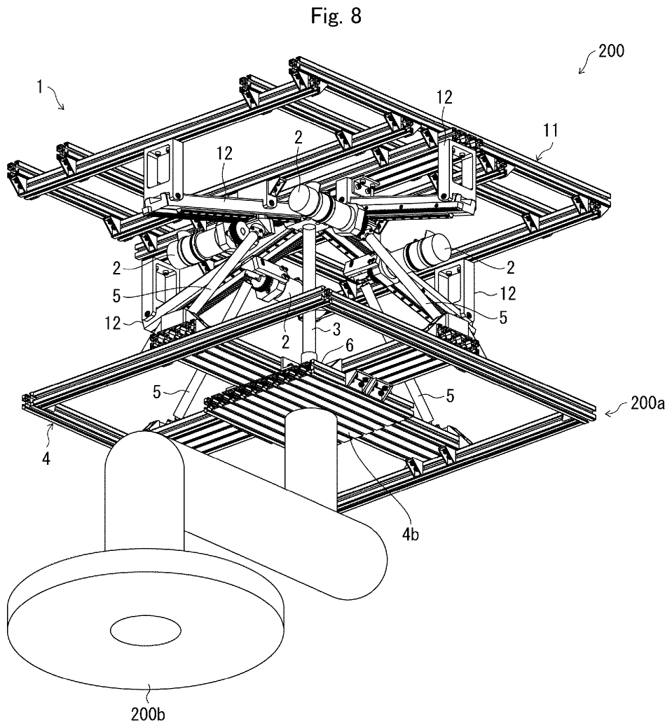

The second embodiment of the present invention is a work robot 200. As shown in FIG. 8, the work robot 200 includes a parallel link mechanism 200a and a tool 200b. The parallel link mechanism 200a in accordance with the present embodiment is disposed above the tool 200b.

### [Configuration of Parallel Link Mechanism]

The parallel link mechanism 200a in accordance with the present embodiment includes (i) a base 1, a plurality of moving bodies 2, a fixed link 3, a turning body 4, a plurality of movable links 5, a sensor 6, and an electric power source 7, which are similar to those of the first embodiment, and (ii) a control substrate 8A as shown in FIG. 2. The parallel link mechanism 200a in accordance with the present embodiment further includes an input part (not illustrated). Note that the electric power source 7 in accordance with the present embodiment may not include a battery (may be constituted by an electric power source circuit and an electric power source cable) and may be configured to receive electric power supply from equipment (e.g., a factory) in which the parallel link mechanism 200a is provided.

### [Differences in Base, Moving Body, Fixed Link, Turning Body, and Movable Link]

As shown in FIG. 8, part of the parallel link mechanism 200a which part does not include an electrical configuration. That is, arrangement of the base 1, the plurality of moving bodies 2, the fixed link 3, the turning body 4, and the plurality of movable links 5 is vertically inverted from that of the parallel link mechanism 100a of the first embodiment. That is, the fixed link 3 extends downward from a center portion of a base main body 11. Further, at least part of a plurality of guide members 124 is/are inclined so as to be raised as the at least part of the plurality of guide members 124 get(s) farther away from the center portion of the base main body 11. The turning body 4 is disposed below the base 1. Further, a center portion of an upper surface of the turning body 4 is connected to a distal end portion of the fixed link 3. The turning body 4 in accordance with the present embodiment has a lower surface to which the tool 200b can be attached. FIG. 8 shows, as an example, the turning body 4 having a plate-like shape, similarly to the first embodiment. However, the shape of the turning body 4 is not limited to the illustrated shape. The shape of the turning body 4 may be any shape, as long as it allows distal end portions of the movable links 5 to be attached to the turning body 4 and it allows the tool 200b to be attached to the turning body 4. Further, each of the moving bodies 2 in accordance with the present embodiment may not include a decelerator 23.

### [Input Part]

The input part receives an operation instruction for the turning body 4. The input part may be (i) a communication part which receives a movement instruction from a teach device or a remote manipulation device or (ii) a terminal connected to the teach device or the remote manipulation device. The teach device is a device which generates an operation instruction in accordance with an input (programming) from a user. The remote manipulation device is a device which detects user's manipulation and/or operation and generates an operation instruction in accordance with a result of the detection. Further, the input part may be a drive which reads the operation instruction from a medium in which a manipulation instruction is stored or a manipulation part which directly accepts manipulation for inputting an operation instruction by a user.

As shown in FIG. 2, the control substrate 8A includes (i) an input-output interface 81, a secondary memory 83, a processor 84, and a bus 85, which are similar to those of the control substrate 8 of the first embodiment, and (ii) a primary memory 82A. The primary memory 82A has a control program (which is different from the one described in the first embodiment) stored therein, the control program causing the parallel link mechanism 200a to operate.

When the processor 84 obtains an operation instruction for the turning body 4, the processor 84 controls movement of the plurality of moving bodies 2 so that the turning body 4 is inclined with respect to the horizontal plane to a degree corresponding to the operation instruction. To be more specific, when a given start condition is established, the processor 84 executes a second front-rear direction process and a second left-right direction process in parallel. The start condition may be, for example, that an electric power source 7 of the work robot 200 (parallel link mechanism 200a) is turned on, that the tool 200b starts operating, that a manipulation part is manipulated, and/or the like.

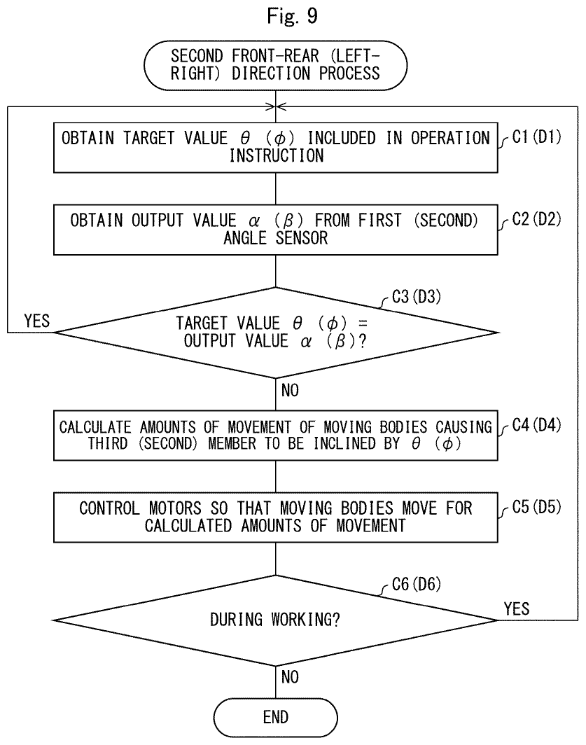

As shown in FIG. 9, in the second front-rear direction process, the processor 84 repeatedly executes a second obtaining step C1, a third obtaining step C2, a third determination step C3, a second calculation step C4, a second control step C5, and a fourth determination step C6. First, in the second obtaining step C1, the processor 84 obtains a target value (an angle θ made by (i) a line of intersection between a plane extending in a front-rear direction and a vertical direction and an attachment surface 4b and (ii) a line of intersection between the plane and a horizontal plane) of inclination of the attachment surface 4b in the front-rear direction, the target value being included in the operation instruction input into the input part. Subsequently, in the third obtaining step C2, the processor 84 obtains an output value a (detected inclination in the front-rear direction) from the first angle sensor. Subsequently, in the third determination step C3, the processor 84 determines whether or not the output value α is equal to the target value θ. If the processor 84 determines that the output value α is equal to the target value θ (C3: YES), the process returns to the second obtaining step C1. Meanwhile, if the processor 84 determines that the output value α is not equal to (i.e., has a difference from) the target value θ (C3: NO), the process returns to the second calculation step C4. In the second calculation step C4, the processor 84 calculates (i) an amount of movement of a moving body 2 located in front of the fixed link 3 and (ii) an amount of movement of a moving body 2 located in the rear of the fixed link 3, the amounts of movement of the moving bodies 2 causing the third member 324 to be inclined with respect to the second member 322 of the movable joint 32 by θ. Subsequently, in the second control step C5, the processor 84 controls the motor 21 of the moving body 2 located in front of the fixed link 3 so that the moving body 2 moves closer to or away from the center portion of the base main body 11 for the amount of movement calculated in the second calculation step C4. Further, in the second control step C5, the processor 84 controls the motor 21 of the moving body 2 located in the rear of the fixed link 3 so that the moving body 2 moves away from or closer to the center portion of the base main body 11 until inclination (the output value α from the first angle sensor) in the front-rear direction of the attachment surface 4b of the turning body 4 becomes equal to the target value θ. Subsequently, in the fourth determination step C6, the processor 84 determines whether or not the work robot 200 is working. If the processor 84 determines that the work robot 200 is working (C6: YES), the process returns to the second obtaining step C1. Meanwhile, if the processor 84 determines that the work robot 200 is not working (C6: NO), the processor 84 ends the second front-rear direction process.

In the second left-right direction process, the processor 84 repeatedly executes a second obtaining step D1, a third obtaining step D2, a third determination step D3, a second calculation step D4, a second control step D5, and a fourth determination step D6. First, in the second obtaining step D1, the processor 84 obtains a target value (an angle φ made by (i) a line of intersection between a plane extending in a left-right direction and the vertical direction and the attachment surface 4b and (ii) a line of intersection between the plane and the horizontal plane) of inclination of the attachment surface 4b in the left-right direction, the target value being included in the operation instruction input into the input part. Subsequently, in the third obtaining step D2, the processor 84 obtains an output value β (detected inclination in the left-right direction) from the second angle sensor. Subsequently, in the third determination step D3, the processor 84 determines whether or not the output value β is equal to the target value o. If the processor 84 determines that the output value β is equal to the target value o (D3: YES), the process returns to the second obtaining step D1. Meanwhile, if the processor 84 determines that the output value β is not equal to (i.e., has a difference from) the target value o (D3: NO), the process returns to the second calculation step D4. In the second calculation step D4, the processor 84 calculates (i) an amount of movement of a moving body 2 located rightward of the fixed link 3 and (ii) an amount of movement of a moving body 2 located leftward of the fixed link 3, the amounts of movement of the moving bodies 2 causing the second member 322 to be inclined with respect to the first member 321 of the movable joint 32 by o. Subsequently, in the second control step D5, the processor 84 controls the motor 21 of the moving body 2 located rightward of the fixed link 3 so that the moving body 2 moves closer to or away from the center portion of the base main body 11 for the amount of movement calculated in the second calculation step D4. Further, in the second control step D5, the processor 84 controls the motor 21 of the moving body 2 located leftward of the fixed link 3 so that the moving body 2 moves away from or closer to the center portion of the base main body 11 until inclination (the output value β from the first angle sensor) in the left-right direction of the attachment surface 4b of the turning body 4 becomes equal to the target value q. Subsequently, in the fourth determination step D6, the processor determines whether or not the work robot 200 is working. If the processor 84 determines that the work robot 200 is working (D6: YES), the process returns to the second obtaining step D1. Meanwhile, if the processor 84 determines that the work robot 200 is not working (D6: NO), the processor 84 ends the second left-right direction process.

### [Tool]

The tool 200b is attached to a lower surface of the turning body 4 of the parallel link mechanism 200a. In FIG. 8, a hand grinder is illustrated as one example of the tool 200b. However, the tool 200b is not limited to this. Alternatively, for example, the tool 200b may be a drill, a cutter, a screwdriver, a hammer, a welding torch, a sucker, a gripping member, or the like.

### <Operation of Work Robot (Parallel Link Mechanism)>

In the work robot 200 configured as above, the tool 200b is attached to a location below the attachment surface 4b of the turning body 4. As discussed above, the work robot 200 (parallel link mechanism 200a) is configured such that the center portion of the turning body 4 is supported by the fixed link 3. That is, the work robot 200 (parallel link mechanism 200a) has high rigidity as a whole. Further, the work robot 200 (parallel link mechanism 200a) is configured such that, instead of the movable links 5, the fixed link 3 takes a load of the tool 200b applied to the center portion of the turning body 4. Thus, the work robot 200 can cause a tool 200b to operate, even if the tool 200b has a heavy weight.

When the manipulation part (not illustrated) is manipulated by a user, the tool 200b starts operating. In a case where the tool 200b is a hand grinder, the tool 200b starts rotating a disc (a saw blade, a grindstone). When the tool 200b starts operating, the processor 84 repeatedly obtains an operation instruction. Further, when the tool 200b starts operating, the sensor 6 repeatedly detects inclination of the attachment surface 4b of the turning body 4 with respect to the horizontal plane. When the work robot 200 obtains an operation instruction for turning the turning body 4, the processor 84 controls the motors 21 of the moving bodies 2 to cause the moving bodies 2 to move. Movement of the moving bodies 2 causes the movable links 5 to move, so that the turning body 4 turns around the first shaft part 323 and/or the second shaft part 325 of the movable joint 32 of the fixed link 3. As discussed above, the four guide members 124 used for movement of the moving bodies 2 extend from the center portion of the base main body 11 to the front side, the rear side, the left side, and the right side, respectively. Thus, the parallel link mechanism 200a can cause the turning body 4 to be inclined in any direction.

In some cases, an operation instruction from the user may be suddenly given. Further, in some cases, the operation instruction may frequently change. However, as discussed above, each of the motors 21 is a direct drive motor. Thus, even if the operation instruction is suddenly given or the operation instruction frequently changes, the work robot 200 (parallel link mechanism 200a) can cause the movable links 5 to move at high speed with high precision, so that the turning body 4 is inclined at a desired angle.

If no changes occurs in the operation instruction while the work robot 200 (parallel link mechanism 200a) is working, the processor 84 stops electric power supply to the motors 21. As discussed above, each of the motors 21 is a direct drive motor. Therefore, merely by stopping electric power supply to the motors 21, the work robot 200 (parallel link mechanism 200a) can cause the moving bodies 2 (the base end portions of the links) to be fixed at the places.

### <Effects of Parallel Link Mechanism and Work Robot>

As discussed above, the parallel link mechanism 200a explained above is inclined so that the guide members 124 are lowered (the guide members 124 get closer to the turning body 4) as the guide members 124 get farther away from the center portion of the base main body 11. Thus, similarly to the parallel link mechanism 100a in accordance with the first embodiment, the parallel link mechanism 200a can be made more compact, as compared to the conventional parallel link mechanisms in each of which equal-length guide members are arranged horizontally. Further, by increasing a horizontal width within a range in which the horizontal width does not to exceed those of the conventional parallel link mechanisms, the parallel link mechanism 200a can increase lengths of the guide members 124 (i.e., movable ranges of the moving bodies 2) as compared to the conventional parallel link mechanisms. Further, the parallel link mechanism 200a can increase the turning width of the turning body 40 obtained by causing the moving bodies 2 to move for a given distance, as compared to that obtained when the conventional parallel link mechanism, in which the guide members are horizontally arranged, causes the moving bodies to move for the same distance. Thus, the parallel link mechanism 200a can achieve an increased turning width of the turning body 4 even without increasing the size of the mechanism.

Further, even without increasing the size of the device, the work robot 200, which includes the above-described parallel link mechanism 200a, can carry out a work by causing the tool 200b to be inclined to a degree (e.g., at approximately) 20° which is difficult for the conventional work robots. Thus, according to the work robot 200, it is not necessary to increase, by use of a mechanism with which a subject to be processed by the tool 200b is inclined, a degree of inclination of the tool 200b with respect to the subject. Further, according to the work robot 200, it is possible to automate at least part of a finishing step which cannot be carried out by the conventional work robots and which has been carried out by a human.

### Variations of First and Second Embodiments

The present invention is not limited to the embodiments, but can be altered by a skilled person in the art within the scope of the claims. The present invention also encompasses, in its technical scope, any embodiment derived by combining technical means disclosed in differing embodiments as appropriate.

For example, some or all of the functions of the processor can be achieved also by a logic circuit. For example, the present invention encompasses, in its scope, an integrated circuit in which a logic circuit that functions as each of the above-described control blocks is formed. In addition, the function of each of the control blocks can be realized by, for example, a quantum computer.

Aspects of the present invention can also be expressed as follows:
A parallel link mechanism in accordance with a first aspect of the present invention includes: a base including a base main body and a plurality of guide members extending from a center portion of the base main body in directions away from the center portion of the base main body toward a periphery of the base main body, the directions being different from each other; a plurality of moving bodies which are movable along the plurality of guide members, respectively; a fixed link having a base end portion fixed to the center portion of the base main body, the fixed link extending in a direction away from the base; a turning body having a center portion connected to a distal end portion of the fixed link, the turning body being turnable around the distal end portion; a plurality of movable links having (i) base end portions respectively connected to the plurality of moving bodies and (ii) distal end portions connected to a periphery of the turning body, the plurality of movable links causing the turning body to turn along with movement of the moving bodies; a sensor configured to detect inclination of the turning body with respect to a horizontal plane; and a processor configured to control, on a basis of a result of detection carried out by the sensor, movement of the plurality of moving bodies so that the turning body is inclined with respect to the horizontal plane to a desired degree, at least any one of the plurality of guide members being inclined so as to get closer to the turning body as the at least any one of the plurality of guide members gets farther away from the center portion of the base main body.

A parallel link mechanism in accordance with a second aspect of the present invention may be configured such that, in the first aspect, the fixed link extends upward from the center portion of the base main body; the turning body is disposed above the base, a center portion of a lower surface of the turning body is connected to the distal end portion of the fixed link, and the turning body is a load-carrying tray having an upper surface on which a load object is placeable; at least any one of the plurality of guide members is inclined so as to be raised as the at least any one of the plurality of guide members gets farther away from the center portion of the base main body; and upon detection of inclination of the turning body, the processor controls movement of the plurality of moving bodies so that the inclination of the turning body is eliminated.

A parallel link mechanism in accordance with a third aspect of the present invention may be configured such that, in the first aspect, the fixed link extends downward from the center portion of the base main body; the turning body is disposed below the base, a center portion of an upper surface of the turning body is connected to the distal end portion of the fixed link, and the lower surface of the turning body allows a tool to be attached thereto; at least any one of the plurality of guide members is inclined so as to be lowered as the at least any one of the plurality of guide members gets farther away from the center portion of the base main body; and in a case where the processor obtains an operation instruction for the turning body, the processor controls movement of the plurality of moving bodies so that the turning body is inclined with respect to the horizontal plane to a degree corresponding to the operation instruction.

A parallel link mechanism in accordance with a fourth aspect of the present invention may be configured such that, in any one of the first to third aspects, the plurality of guide members include racks extending in parallel with the plurality of guide members, respectively; and the plurality of moving bodies respectively include motors each configured to rotate according to control of the processor and pinions each configured to engage with a corresponding one of the racks and to rotate along with rotation of a corresponding one of the motors.

A parallel link mechanism in accordance with a fifth aspect of the present invention may be configured such that, in the fourth aspect, each of the motors is a direct drive motor.

A parallel link mechanism in accordance with a sixth aspect of the present invention may be configured such that, in the fourth or fifth aspect, the plurality of moving bodies include decelerators between the motors and the pinions, respectively.

A parallel link mechanism in accordance with a seventh aspect of the present invention may be configured such that, in any one of the fourth to sixth aspects, the plurality of moving bodies respectively include encoders each configured to detect a rotation direction and a rotation angle of a corresponding one of the motors; and the processor causes the motors to rotate on a basis of a result of detection carried out by the encoders.

A parallel link mechanism in accordance with an eighth aspect of the present invention may be configured such that, in any one of the first to seventh aspects, the plurality of guide members extend from the center portion of the base main body to a front side, a rear side, a left side, and a right side, respectively, and the plurality of guide members are inclined so as to get closer to the turning body as the plurality of guide members get farther away from the center portion of the base main body; and the distal end portions of the plurality of movable links are connected to a front end portion, a rear end portion, a left end portion, and a right end portion of the turning body, respectively.

A parallel link mechanism in accordance with a ninth aspect of the present invention may be configured such that, in any one of the first to eighth aspects, the distal end portion of the fixed link is a movable joint at the center portion of the turning body, the movable joint having a shaft part extending in a direction orthogonal to a direction in which the fixed link extends; and the turning body is connected to the fixed link such that the turning body is turnable around the shaft part.

A parallel link mechanism in accordance with a tenth aspect of the present invention may be configured such that, in the ninth aspect, the movable joint includes a first shaft part extending in a front-rear direction and a second shaft part extending in a left-right direction; and the turning body is connected to the fixed link such that the turning body is turnable around the first shaft part and the turning body is turnable around the second shaft part.

A transfer device in accordance with an eleventh aspect of the present invention includes: a traveling mechanism capable of traveling on a ground; and a parallel link mechanism in accordance with the second aspect, the parallel link mechanism being mounted above the traveling mechanism.

A work robot in accordance with a twelfth aspect of the present invention includes: a parallel link mechanism in accordance with the third aspect; and a tool attached to the lower surface of the turning body of the parallel link mechanism.

1. A parallel link mechanism comprising:
a base including
a base main body and
a plurality of guide members extending from a center portion of the base main body in directions away from the center portion of the base main body toward a periphery of the base main body, the directions being different from each other;
a plurality of moving bodies which are movable along the plurality of guide members, respectively;
a fixed link having a base end portion fixed to the center portion of the base main body, the fixed link extending in a direction away from the base;
a turning body having a center portion connected to a distal end portion of the fixed link, the turning body being turnable around the distal end portion;
a plurality of movable links having (i) base end portions respectively connected to the plurality of moving bodies and (ii) distal end portions connected to a periphery of the turning body, the plurality of movable links causing the turning body to turn along with movement of the moving bodies;
a sensor configured to detect inclination of the turning body with respect to a horizontal plane; and
a processor configured to control, on a basis of a result of detection carried out by the sensor, movement of the plurality of moving bodies so that the turning body is inclined with respect to the horizontal plane to a desired degree,
at least any one of the plurality of guide members being inclined so as to get closer to the turning body as the at least any one of the plurality of guide members gets farther away from the center portion of the base main body.

2. The parallel link mechanism according to claim 1, wherein:
the fixed link extends upward from the center portion of the base main body;
the turning body is disposed above the base, a center portion of a lower surface of the turning body is connected to the distal end portion of the fixed link, and the turning body is a load-carrying tray having an upper surface on which a load object is placeable;
at least any one of the plurality of guide members is inclined so as to be raised as the at least any one of the plurality of guide members gets farther away from the center portion of the base main body; and
upon detection of inclination of the turning body, the processor controls movement of the plurality of moving bodies so that the inclination of the turning body is eliminated.

3. The parallel link mechanism according to claim 1, wherein:
the fixed link extends downward from the center portion of the base main body;
the turning body is disposed below the base, a center portion of an upper surface of the turning body is connected to the distal end portion of the fixed link, and the lower surface of the turning body allows a tool to be attached thereto;
at least any one of the plurality of guide members is inclined so as to be lowered as the at least any one of the plurality of guide members gets farther away from the center portion of the base main body; and
in a case where the processor obtains an operation instruction for the turning body, the processor controls movement of the plurality of moving bodies so that the turning body is inclined with respect to the horizontal plane to a degree corresponding to the operation instruction.

4. The parallel link mechanism according to claim 1, wherein:
the base includes a plurality of racks extending in parallel with the plurality of guide members, respectively; and
the plurality of moving bodies respectively include
motors each configured to rotate according to control of the processor and
pinions each configured to engage with a corresponding one of the plurality of racks and to rotate along with rotation of a corresponding one of the motors.

5. The parallel link mechanism according to claim 4, wherein:
each of the motors is a direct drive motor.

6. The parallel link mechanism according to claim 4, wherein:
the plurality of moving bodies include decelerators between the motors and the pinions, respectively.

7. The parallel link mechanism according to claim 4, wherein:
the plurality of moving bodies respectively include encoders each configured to detect a rotation direction and a rotation angle of a corresponding one of the motors; and
the processor causes the motors to rotate on a basis of a result of detection carried out by the encoders.

8. The parallel link mechanism according to claim 1, wherein:
the plurality of guide members extend from the center portion of the base main body to a front side, a rear side, a left side, and a right side, respectively, and the plurality of guide members are inclined so as to get closer to the turning body as the plurality of guide members get farther away from the center portion of the base main body; and
the distal end portions of the plurality of movable links are connected to a front end portion, a rear end portion, a left end portion, and a right end portion of the turning body, respectively.

9. The parallel link mechanism according to claim 1, wherein:
the distal end portion of the fixed link is a movable joint at the center portion of the turning body, the movable joint having a shaft part extending in a direction orthogonal to a direction in which the fixed link extends; and
the turning body is connected to the fixed link such that the turning body is turnable around the shaft part.

10. The parallel link mechanism according to claim 9, wherein:
the movable joint includes
a first shaft part extending in a front-rear direction and
a second shaft part extending in a left-right direction; and
the turning body is connected to the fixed link such that the turning body is turnable around the first shaft part and the turning body is turnable around the second shaft part.

11. A transfer device comprising:
a traveling mechanism capable of traveling on a ground; and
a parallel link mechanism recited in claim 2, the parallel link mechanism being mounted above the traveling mechanism.

12. A work robot comprising:
a parallel link mechanism recited in claim 3; and
a tool attached to the lower surface of the turning body of the parallel link mechanism.
